(19) United States
(12) Patent Application Publication
(10) Pub. No.: US 2019/0318669 A1
(43) Pub. Date: Oct. 17, 2019

(54) DISPLAY ASSEMBLY INCLUDING AT LEAST TWO DISPLAY DEVICES

(71) Applicant: SEAMLESS TECHNOLOGY INC., Taipei (TW)

(72) Inventors: I-WEI WU, New Taipei (TW); CHIH-LUNG HUNG, New Taipei (TW); HSIAO-MIN YIN, Hsinchu (TW)

(21) Appl. No.: 16/357,994

(22) Filed: Mar. 19, 2019

Related U.S. Application Data
(60) Provisional application No. 62/655,816, filed on Apr. 11, 2018.

(51) Int. Cl. G09F 9/302; G09G 3/20; F21V 8/00

(52) U.S. Cl. CPC G09F 9/3026; G09G 3/20; G09G 2320/02; G09G 2300/026; G02B 6/0005

(57) ABSTRACT

A display assembly includes at least two display devices and two image compensating elements at a juxtaposition of every adjacent two display devices. Each display device includes a front surface that is viewed by user. Each front surface defines a display area and a border area. Each image compensating element is on the front surface. Each image compensating element includes a light-incident surface on the display area, a light-emitting surface coupling to the light-incident surface, and a connecting surface coupling between the light-incident surface and the light-emitting surface. Each image compensating element includes a plurality of light guiding channels. Light guiding paths of the light guiding channels curvedly extend along a direction from the light-incident surface toward the light-emitting surface.

### FIELD

The subject matter herein generally relates to a display assembly including at least two display devices.

### BACKGROUND

To achieve a large display screen, a plurality of display devices can be coupled (referred to as “splicing”) together to achieve a single large display. Each display device has a display area in which a plurality of display pixels are arranged and a border area surrounding the display area. However, when several display devices are spliced together, the border areas appear as grids imposed over the full display image. The display images are presented to viewers as non-continuous images.

Therefore, there is room for improvement in the art.

### BRIEF DESCRIPTION OF THE DRAWINGS

Implementations of the present technology will now be described, by way of embodiments only, with reference to the attached figures.

FIG. 1 is a top view of a display assembly according to a first embodiment of the present disclosure.

FIG. 2 is a front view of the display assembly of FIG. 1.

FIG. 3 is an enlarged view of a portion of the display assembly of FIG. 1.

FIG. 4 is an enlarged view of a single display device in the display assembly of FIG. 3.

FIG. 5 is a top view of a portion of a display assembly according to a second embodiment of the present disclosure.

FIG. 6 is a top view of a display assembly according to a third embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

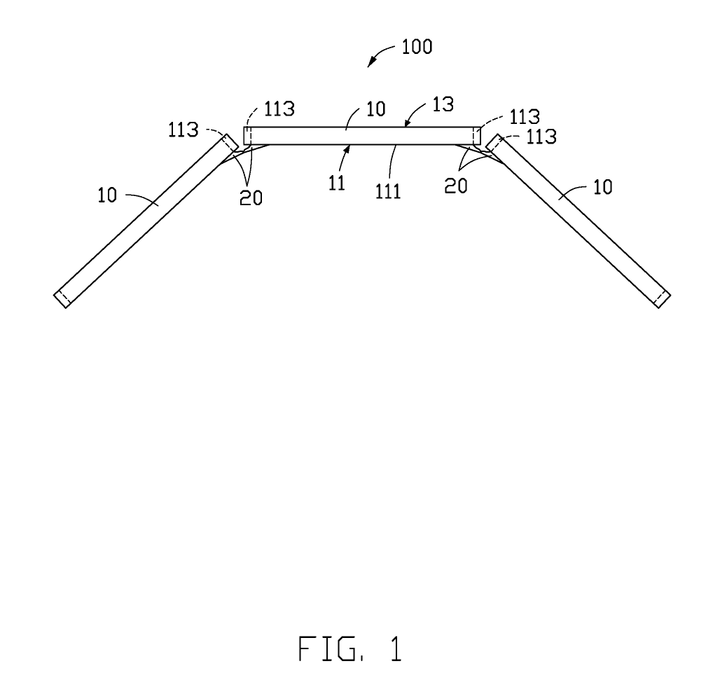

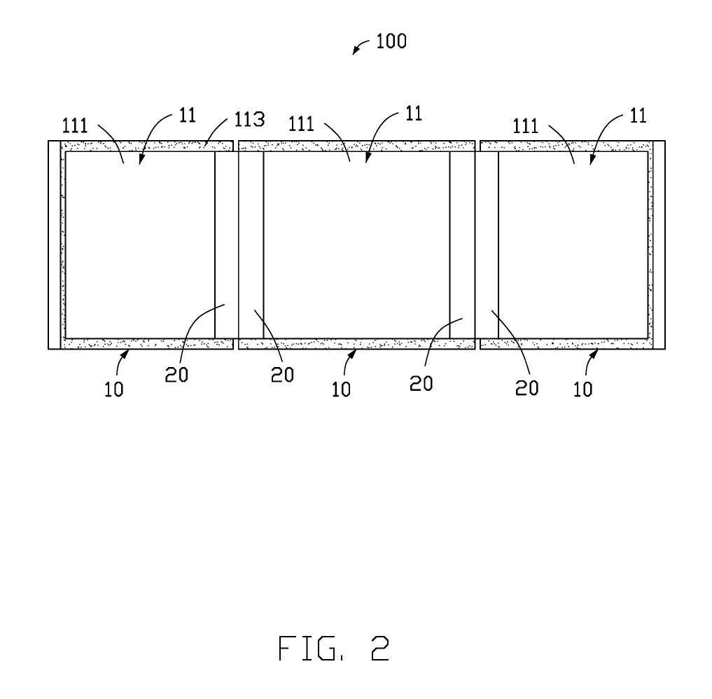

FIG. 1 and FIG. 2 illustrate a display assembly 100 of a first embodiment. The display assembly 100 includes three display devices 10 arranged in the manner of a triptych. Adjacent display devices 10 are not in one plane, but are tilted relative to each other at an angle of less than 180 degrees from each other. Each display device 10 includes a front surface 11 and a back surface 13 opposite to the front surface 11. The front surface 11 is viewable and may be touched by users. The front surface 11 defines a display area 111 for displaying images and a border area 113 outside the display area 111. The border area 113 surrounds the display area 111. In the present embodiment, the border area 113 is on both sides of the display area 111. The two front surfaces 11 of adjacent display devices 10 intersect at an angle of less than 180 degrees.

The number of the display devices 10 in the display assembly 100 is not limited to three. In other embodiments, the display assembly 100 may include two display devices 10 or four display devices 10, as long as the number of the display devices 10 is equal to or greater than two.

When adjacent display devices 10 are spliced together, the two border areas 113 of the two display devices 10 are at a juxtaposition of the two display devices 10. In the present embodiment, the two border areas 113 of the two display devices 10 are spaced apart from each other. In other embodiments, the two border areas 113 of the two display devices 10 may be in contact with each other.

As shown in FIG. 1 and FIG. 2, at least one image compensation component 20 is provided on the front surface 11 of each display device 10 in order to present a continuous or non-interrupted display by the display assembly 100 without being affected by the border areas 113 of the display devices 10. In other words, the border area 113 is not viewable in a combined image from the display devices 10. The image compensation component 20 can transmit a portion of images such that the images spliced together from the display devices 10 to form a continuous and non-reticulated display which is viewable when facing the front surfaces 11 of the display devices 10. The display assembly 100 can thus display the combined image without the border areas 113 interrupting the image.

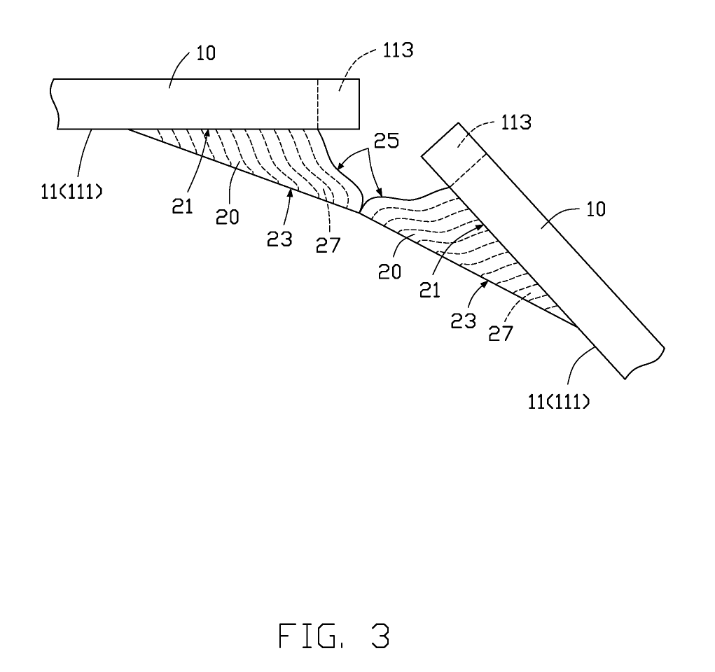

Referring to FIG. 3, two image compensating elements 20 are positioned at a juxtaposition of adjacent display devices 10, and one image compensating element 20 is located on one display device 10. Each of the image compensating elements 20 is on the front surface 11, within the display area 111, and adjacent to the border area 113 of the display device 10. The image compensating element 20 does not contact the border area 113 of the front surface 11 but effectively overhangs and conceals the border area 13. In the present embodiment, a portion of the display area 111 that is not covered by the image compensating element 20 is defined as a main display area, and other portion of the display area 111 that is covered by the image compensating element 20 is defined as an infill display area. The infill display area is outside of the main display area.

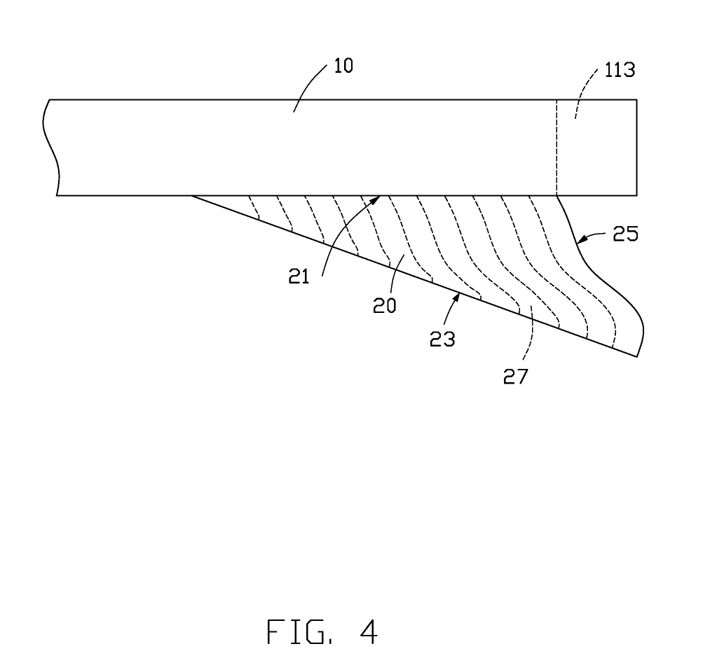

Referring to FIG. 3 and FIG. 4, the image compensating element 20 is a triangular prism. The image compensating element 20 includes a light-incident surface 21, a light-emitting surface 23, and a connecting surface 25 which connects each of the light-incident surface 21 and the light-emitting surface 23. The light-incident surface 21, the light-emitting surface 23, and the connecting surface 25 define the three side surfaces of the triangular prism. In the present embodiment, each of the light-incident surface 21 and the light-emitting surface 23 is a flat surface. The connecting surface 25 is a curved surface. The light-incident surface 21 covers the display area 111 of the front surface 11 of the display device 10 but does not cover the border area 113. The light-emitting surface 23 intersects with the light-incident surface 21 to form an acute angle. The connecting surface 25 is connected between the light-emitting surface 23 and the light-incident surface 21.

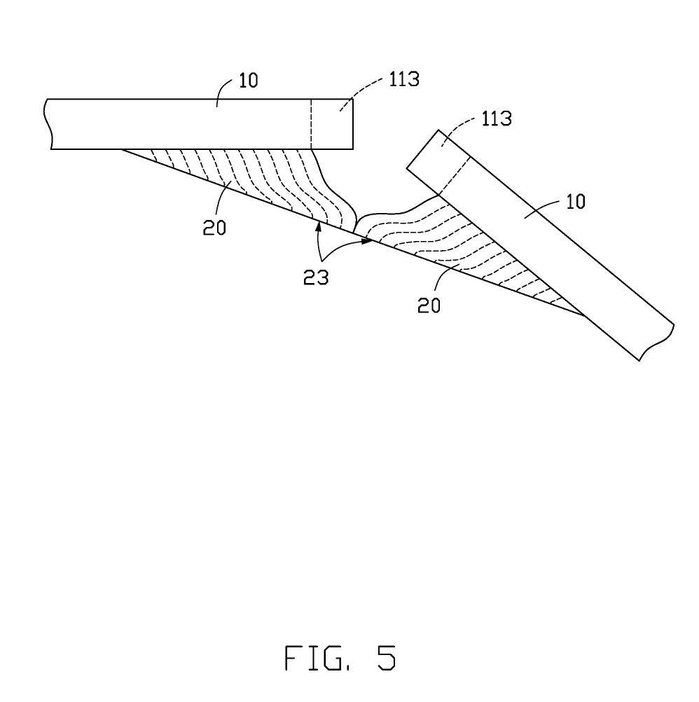

Referring to FIG. 3, the two light-emitting surfaces 23 of the two image compensating elements 20 at the juxtaposition of two adjacent display devices 10 are coupled together. In the present embodiment, the two light-emitting surfaces 23 at the juxtaposition of every adjacent two display devices 10 intersect at an angle of less than 180 degrees. In other embodiments, as shown in FIG. 5, the two light-emitting surfaces 23 of the two image compensating elements 20 at the juxtaposition of every adjacent two display devices 10 are in one plane.

The image compensating element 20 includes a plurality of light guiding channels 27. Light guiding paths of the light guiding channels 27 are independent from each other and extend along a direction from the light-incident surface 21 toward the light-emitting surface 23. Each light guiding channel 27 is substantially curved. The light guiding channels 27 are bundled together to form the image compensating element 20.

In one embodiment, each light guiding channel 27 is a light guiding fiber, and each light guiding fiber extends from the light-incident surface 21 toward the light-emitting surface 23. In other embodiments, the light guiding fiber may be a plastic optical fiber, a quartz optical fiber, a glass optical fiber, or the like.

In a conventional image compensating element (such as a light guiding fiber block), the light guiding fibers generally extend in a straight line, and the optical axes directions of the light guiding fibers generally overhang and lean above the border area, thereby shielding the border area. Such an arrangement may result in a brightness of images displayed on the image compensating elements being lower than a brightness of images displayed on other areas of the display devices. Applicant of the present disclosure has conducted experiment and discovered that an optimum image display is achieved when the optical axes directions of the optical fibers are perpendicular to the light-emitting surface of the light guiding fiber block, a viewing angle is optimum, and a brightness of the infill display area corresponding to the image compensating element and a brightness of the main display area are of similar levels.

As shown in FIG. 4, in this embodiment, each of the light guiding channels 27 of each of the image compensating elements 20 first extends in a direction leaning toward the border area 113 and then bends and extends so that the optical axis direction of the light guiding channel 27 at the light emitting surface 23 is approximately perpendicular to the light emitting surface 23. In the embodiment as shown in FIG. 4, the optical axis direction of the light guiding channel 27 on the light-emitting surface 23 intersect with the light-emitting surface 23 at an angle in a range of 75-105 degrees. As shown in FIG. 3, an area size of the light-incident surface 21 is greater than an area size of the light-emitting surface 23.

Light from the main display area of the display device 10 is passed directly to the user, and the user can view all of the main display area. Light from the pixels of the infill display area of the display device 10 enters into the light guiding channels 27 from the light-incident surface 21 of the compensating element 20 and is emitted from the light-emitting surface 23 of the image compensating element 20. The juxtapositioning of adjacent image compensating elements 20 means that when the viewer views the display screen of the display assembly 100, the border areas 113 at the juxtaposition of adjacent display devices 10 are effectively not visible, so an uninterrupted display can be viewed. The image compensating element 20 extends images corresponding to the infield infill display areas of adjacent display devices 10 above the border areas 113, and the border areas 113 are shielded from view, thus a seamless display can be achieved. The image compensating elements 20 render overall images on the display devices 10 visually seamless.

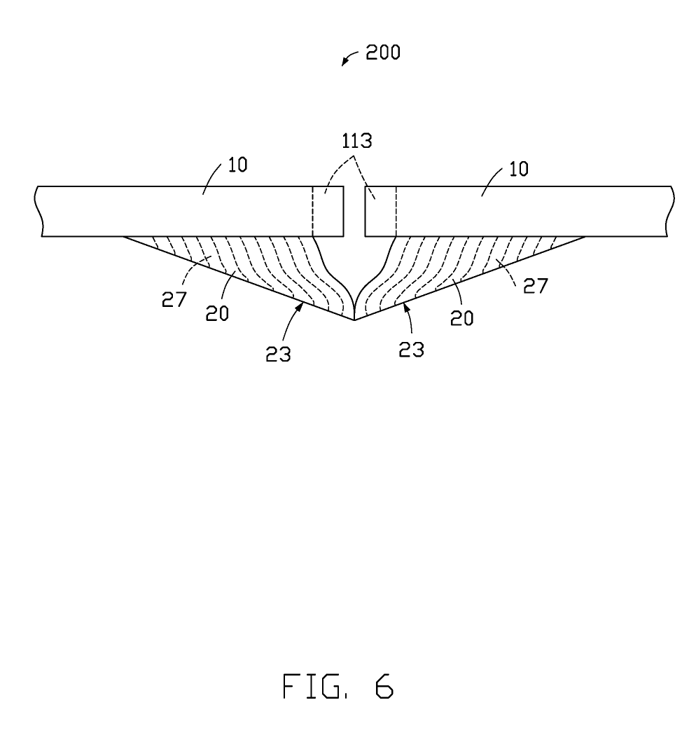

FIG. 6 illustrates a display assembly 200 of an embodiment. The display assembly 200 includes two display devices 10 arranged in one plane. The display assembly 200 is substantially the same as the display assembly 100. In the display assembly 200, two image compensating element 20 are positioned at a juxtaposition of adjacent display devices 10, one image compensating element 20 is located on one display device 10. The light guiding channel 27 of the image compensating element 20 first extends in a direction leaning toward the border area 113 and then bends and continues so that the optical axis direction of the light guiding channel 27 on the light-emitting surface 23 is approximately perpendicular to the light-emitting surface 23. In the embodiment as disclosed in FIG. 6, the optical axis direction of the light guiding channel 27 on the light-emitting surface 23 and the light-emitting surface 23 form an angle in a range of 75-105 degrees. In one embodiment, the optical axis direction of the light guiding channel 27 is perpendicular to the light emitting surface 23.

In this disclosure, the image compensating element 20 may be formed by extrusion molding a light guiding fiber block (not shown) and cutting the light guiding fiber block to a predetermined shape, wherein the light guiding fiber block includes a closely arranged plurality of light guiding fibers extending in a predetermined direction. The image compensating element formed by the extrusion molding can be applied to a display device with a wide border area of various widths. Therefore, display devices with narrow border areas are not prerequisite for the display assembly of the present disclosure, which can effectively reduce the cost of the display assembly.

A method for making the image compensating element 20 may include: providing a light guiding fiber block (not shown) which includes a plurality of light guiding fibers extending in a predetermined direction and closely arranged in an array. The light guiding fiber block is placed into an extrusion mold and the light guiding fiber block is extruded at a high temperature to change the extending directions of the light guiding fibers, the light guiding fiber block is then cut after the extrusion to obtain the image compensating element with a pre-determined shape.

The display device 10 can be a liquid crystal display device, an organic light emitting diode display device, a micro-light emitting diode display device, and the like.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A display assembly, comprising:
at least two display devices arranged side by side, each of the at least two display devices comprising a front surface adapted for displaying image, the front surface defining a display area and a border area outside the display area; and
two image compensating elements at a juxtaposition of every adjacent two of the display devices, each of the two image compensating elements being on the front surface of a corresponding one of the adjacent two display devices;
each of the image compensating elements comprising a light-incident surface on the display area, a light-emitting surface coupling to the light-incident surface, and a connecting surface coupling between the light-incident surface and the light-emitting surface;
wherein each of the image compensating elements comprises a plurality of light guiding channels; light guiding paths of the plurality of light guiding channels are independent from each other and curvedly extend along a direction from the light-incident surface toward the light-emitting surface; optical axis direction of each of the plurality of light guiding channels on the light-emitting surface intersects with the light-emitting surface at an angle in a range of 75 degrees to 105 degrees.

2. The display assembly of claim 1, wherein the optical axis direction of each of the plurality of light guiding channels on the light-emitting surface is perpendicular to the light-emitting surface.

3. The display assembly of claim 1, wherein the light-emitting surfaces of the two image compensating elements at the juxtaposition of the adjacent two display devices are coupled together.

4. The display assembly of claim 3, wherein the two light-emitting surfaces of the two image compensating elements at the juxtaposition of the adjacent two display devices are coupled into one plane.

5. The display assembly of claim 1, wherein each of the image compensating elements defines an acute angle formed by the light-emitting surface intersects with the light-incident surface.

6. The display assembly of claim 1, wherein the connecting surface is a curved surface.

7. The display assembly of claim 1, wherein an area size of the light-incident surface is smaller than an area size of the light-emitting surface.

8. The display assembly of claim 1, wherein each of the plurality of light guiding channels is a light guiding fiber.

9. The display assembly of claim 1, wherein two front surfaces of every adjacent two of the display devices intersects with each other at an angle of less than 180 degrees.

10. The display assembly of claim 1, wherein the at least two display devices are arranged in one plane.
